(19) United States
(12) Patent Application Publication
(10) Pub. No.: US 2015/0358333 A1
(43) Pub. Date: Dec. 10, 2015

(54) GEO-LOCATION AND BIOMETRIC PRESENCE SECURITY

(71) Applicant: GrandiOs Technologies, LLC, Wilmington, DE (US)

(72) Inventor: John Cronin, Bonita Springs, FL (US)

(21) Appl. No.: 14/622,806

(22) Filed: Feb. 13, 2015

Related U.S. Application Data
(60) Provisional application No. 62/007,828, filed on Jun. 4, 2014.

(51) Int. Cl. H04L 29/06

(52) U.S. Cl. CPC H04L 63/107; H04L 63/0861

(57) ABSTRACT

Geo-location and biometric security systems and methods are provided for authenticating a user of a mobile device. The geo-location and biometric security system may include a plurality of human biometric and geo-location security functions on the user device. The biometric and geo-location security functions may be set in any combination by the user to determine the security conditions for the device to enable resources or applications local to or remote from the user device. In certain instances, the applications enabled by the present invention are secure financial transactions.

### CROSS-REFERENCE TO RELATED APPLICATIONS

The present application claims the priority benefit of U.S. provisional application No. 62/007,828 filed Jun. 4, 2014 and entitled “Geo-Location and Biometric Presence Security,” the disclosure of which is incorporated herein by reference.

### BACKGROUND OF THE INVENTION

1. Field of the Invention

The present invention relates generally to mobile devices, and more particularly, to a geo-location and biometric security systems

2. Description of the Related Art

Handheld electronic devices, such as smartphones, typically have a security function embedded in their operating system (OS) that may be used to access a user device. In one example, the security function may use a biometric input such as a fingerprint scan to unlock a user device. In yet another example, the security function may use a geographical location (“geo-location”) function to automatically unlock a user device within a location or location range pre-defined by the user. Existing geo-location security implementations do not allow a user of a mobile electronic device to define a home location as an authorized location for gaining access to a resource or applications.

In certain instances, a single security function may not be adequate to ensure that the device is not unlocked only by an authorized user, or that installed applications can only be by accessed by the true owner of the device. While there are dual biometric solutions on the market today where physical parameters of the user, such as voice, eye detection, face recognition or the like are combined, no device combines both geo-location and biometric security functions in a mobile electronic device. Furthermore, dual biometrics have yet to be adopted in wide use because of the complex nature of managing and performing dual sets of biometrics. Therefore, new approaches are needed for providing secure access to a user device and/or applications installed on a user device that may be simpler and faster that current implementations.

### SUMMARY OF THE PRESENTLY CLAIMED INVENTION

Geo-location and biometric security systems and methods for authenticating a user of a mobile device are disclosed. Exemplary geo-location and biometric security systems may include a plurality of human biometric and geo-location security functions that are embedded at least in part into the operating system of the user device. Biometric and geo-location security functions may be set in any combination by the user to determine the security conditions for the device to enable resources or applications local to or remote from the user device. In certain instances, the applications enabled by the present invention may be secure financial transactions.

Virtually any number of geo-locations may be pre-defined as “home locations” for the user device. In some embodiments, geo-location data may be the only security condition required to enable the device or application. In other instances, geo-location data and a biometric input may be required to enable the device or application. In yet another instance, a user may setup different sets of geo-location and biometric security conditions to enable different functions or applications. For example, a security condition may require that at least one biometric (e.g., a fingerprint scan) be input when the mobile electronic device is at a particular geo-location. In another example, a security condition may require at least one biometric (e.g., a retina scan) be input when the mobile electronic device is at one of three geo-locations. As such, a layer of security based on geo-location may provide an additional level of security to those implemented on mobile electronic devices.

Embodiments of the present invention may include methods for geo-location and biometric security. Such methods may include displaying a user interface on a mobile electronic device, receiving a selection of a home location through the user interface, receiving a selection of a resource, and determining that a location of the mobile electronic device is the home location. Further, access to the selected resource may only be allowed when the mobile electronic device is located at the home location.

### BRIEF DESCRIPTION OF THE DRAWINGS

FIG. 1 illustrates an exemplary system for geo-location and biometric security in different geo-locations.

FIG. 2 illustrates exemplary operating system settings on a mobile device that may be used in a system for geo-location and biometric security.

FIG. 3A is a flowchart illustrating an exemplary method for geo-location and biometric security.

FIG. 3B is a chart of exemplary chart of how resources may be secured by a system for geo-location and biometric security.

FIG. 4 is a flowchart illustrating an alternative method for geo-location and biometric security.

FIG. 5 illustrates an exemplary device architecture of a device that may be used in a system for geo-location and biometric security.

### DETAILED DESCRIPTION

Embodiments of the present invention provide systems and methods for geo-location and biometric security. A user may be authenticated before being given access to certain functions or applications installed on the user device. In various embodiments, the geo-location and biometric security system uses geographical location (geo-location) in conjunction with another biometric security condition before allowing the user device to be unlocked. In certain instances, the security condition unlocks a locked user device, while in other instances the security condition allows access to an application (e.g., online banking or shopping).

Virtually any number of geo-locations may be pre-defined as “home locations” for the user device. In some embodiments, geo-location data may be the only security condition required to enable the device or application. In other instances, geo-location data and a biometric input may be required to enable the device or application. In yet another instance, a user may setup different sets of geo-location and biometric security conditions to enable different functions or applications. For example, a security condition may require that at least one biometric (e.g., a fingerprint scan) be input when the mobile electronic device is at a particular geo-location. In another example, a security condition may require at least one biometric (e.g., a retina scan) be input when the mobile electronic device is at one of three geo-locations. As such, a layer of security based on geo-location may provide an additional level of security to those implemented on mobile electronic devices.

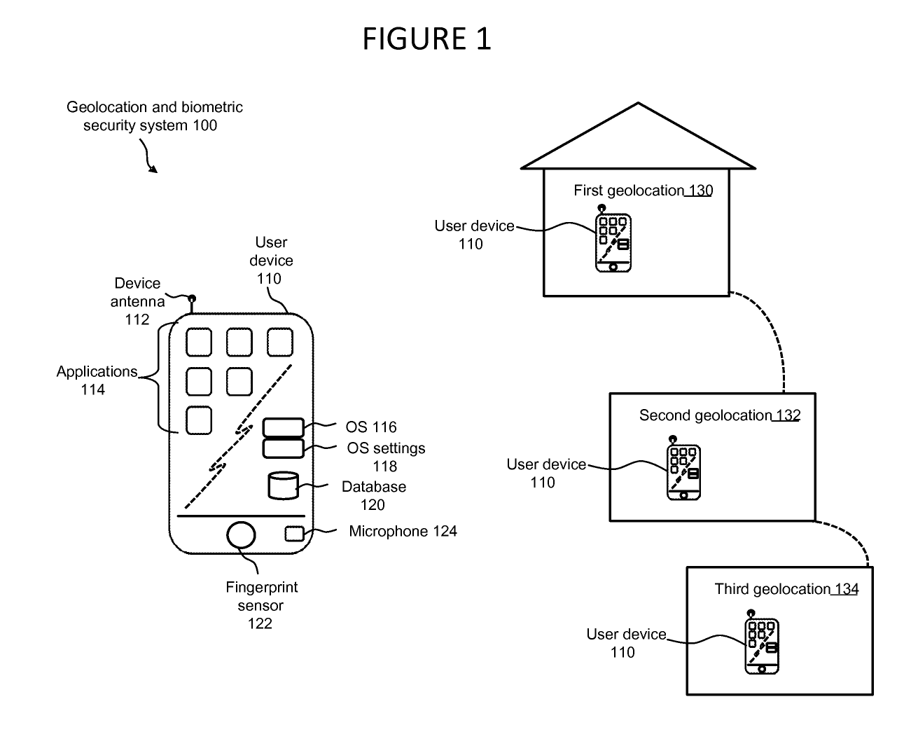

FIG. 1 illustrates an exemplary system 100 for geo-location and biometric security in different geo-locations 130-134. User device 110 is a mobile electronic device that includes a device antenna 112, software applications 114, operating system (OS)116, operating system settings 118, database 120, fingerprint sensor 122, and microphone 124.

Users may use any number of different electronic user devices 110, such as general purpose computers, mobile phones, smartphones, personal digital assistants (PDAs), portable computing devices (e.g., laptop, netbook, tablets), desktop computing devices, handheld computing device, or any other type of computing device capable of communicating over communication network 130. User devices 110 may also be configured to access data from other storage media, such as memory cards or disk drives as may be appropriate in the case of downloaded services. User device 110 may include standard hardware computing components such as network and media interfaces, non-transitory computer-readable storage (memory), and processors for executing instructions that may be stored in memory.

Device antenna 112 of user device 110 may be an antenna that allows user device 110 to communicate wirelessly over the communication network 130. Such antenna 112 may communicate over WiFi, 4G/3G, Bluetooth, and/or any other known radio frequency communication network known in the art.

Applications 114 may include any number of software applications installed on the user device 110, including native applications (e.g., Notes, Messages, Camera, FaceTime, Weather, etc. on iPhone) and downloaded applications, which may include various social media applications (e.g., Facebook®, Twitter®, Instagram®).

Operating system 116 of user device 110 is a collection of software that manages computer hardware resources and provides common services for computer programs, including applications 114. The operating system 116 is an essential component of the system software in a computer system. Applications 114 are usually developed for a specific operation system 116 and therefore rely on the associated operating system 116 to perform its functions. For hardware functions such as input and output and memory allocation, the operating system 116 acts as an intermediary between applications 114 and the computer hardware. Although application code is usually executed directly by the hardware, applications 114 may frequently make a system call to an OS function or be interrupted by it. Operating systems 116 can be found on almost any device with computing or processing ability. Examples of popular modern operating systems include Android, BSD, iOS, Linux, OS X, QNX, Microsoft Windows, Windows Phone, and IBM z/OS. Most of these (except Windows, Windows Phone and z/OS) may share roots in UNIX.

Operating system settings 118 of user device 110 may be a software function that opens a display that lists OS functions that may be generated upon selection of a user interface button. Such a list of OS functions may be associated with various options that allow the user to designate certain preferences or settings with respect to how certain operating system functions are performed (e.g., display preferences, wireless network preferences, information sharing, accessibility of applications to system information, such as GPS/location, notifications). Once these settings 118 are set, the operating system 116 uses the settings 118 to perform various functions, which includes functions related to execution of an application 114. For example, selecting certain operating system settings 118 in the user interface may cause a list of geo-location parameters to be displayed on the user interface.

Database 120 may be a local database for information storage and analysis and may include, for example, storage and analysis of biometric and geo-location data from user device 110. An organized collection of data, database 120 may be typically organized to model relevant aspects of reality in a way that supports processes requiring this information. Such a database 120 may be embodied in any type of memory known in the art for storage on a mobile device, such as user device 110.

Fingerprint sensor 122 may be a sensor that captures a digital scan of a fingerprint pattern. In certain instances, fingerprint sensor 122 may be used to create a biometric template that is stored in database 120 for use in in a biometric authentication process. Fingerprint sensor 122 may also be a mechanism to turn user device 110 on or off. While fingerprints may be referenced herein, any biometric known in the art may be used (e.g., retina scan), and fingerprint sensor 122 may further include devices known in the art for capturing and processing scans of the same.

Microphone 124 is a microphone for recording or inputting transmitting sound into user device 110. In certain instances, microphone 124 may be used to capture a user's voiceprint when configuring user device 110 to use such voiceprint as an authentication measure. Such voiceprint and data regarding the same may be stored to local database 120 for comparison to later-received voiceprints. In that regard, microphone 124 may be used to capture a voice biometric input to compare to the stored voiceprint. Upon detecting a match, user device 110 may then unlock for usage or for usage of certain functions or applications.

First geo-location 130, second geo-location 132, and third geo-location 134 may be three different physical locations where the user device 110 may be set to unlock under different conditions. For example, the first geo-location 130 may be the user's house where the user device 110 may be set to unlock without any further biometric input. The second geo-location 132 may be the user's office where the user device may be set to unlock with a fingerprint input, and the third geo-location 134 may be a local Starbucks 134 where the user device may be set to unlock with a fingerprint and voiceprint.

In configuring user device 110 to impose security measures based on both geo-location and biometric data, a user may initialize via operating system settings 118 a selected geo-location and selected biometric input(s) to be required to access a certain resource. For example, the user may designate that a work-related application may only be opened in the user's workplace without biometric input. Alternatively, the user may designate that personal or sensitive financial files may only be opened in the user's home after providing both a fingerprint and a voiceprint.

The user may use fingerprint sensor 122 to capture a digital image of a fingerprint pattern, thereby creating a biometric fingerprint template. The fingerprint biometric template may be stored in database 120 and used in a biometric authentication process. In one example, an authentication process may be used to securely turn user device 110 on. In another example, an authentication process may be used to authorize a transaction process like online banking or making an online purchase using user device 110. In another example, a user may use microphone 124 to record a voice recording to create a voiceprint biometric template. The voiceprint biometric template may be stored in database 120 and used in a biometric authentication process. In yet another example, a user may set the security of user device based on geo-location data. The geo-location may include one or more locations frequented by the user, such as geo-locations 130-134. Furthermore, the geo-location data may be stored in database 120 and used as a condition similar to biometrics in an authentication process. Geo-location and biometric data may be used individually or in any combination when setting a security level on user device 110.

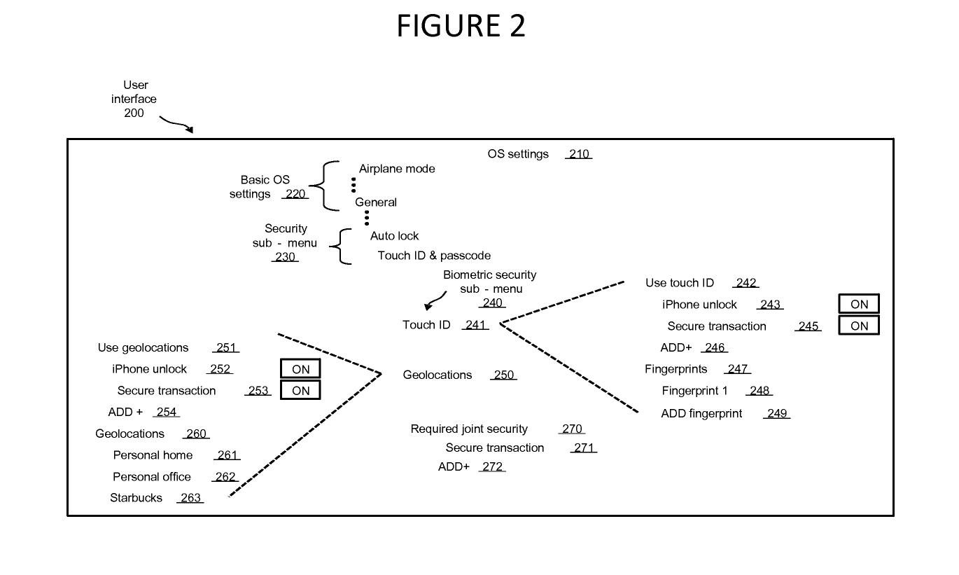

FIG. 2 illustrates exemplary operating system settings 210 on a user interface 200 of mobile device that may be used in a system for geo-location and biometric security. Operating system settings 210 may include basic OS settings 220, security sub-menu 230, biometric security sub-menu 240, geo-locations 250, required joint security 270, and other transactions to be added 272.

Basic OS settings 220 may be any settings known in the art (e.g., airplane mode and general settings) for the particular user device 110. Security sub-menu 230 may include options regarding auto lock and touch ID & passcode, which may further include the biometric security sub-menu 240. Biometric security sub-menu 240 may further include touch ID 241 options for use touch ID 242, iPhone unlock 243, secure transaction 245, Add+ 246, fingerprints 248, fingerprint 1 248, and add fingerprint 249. Geo-locations 250 sub-menu may include use geo-locations 251, iPhone unlock 252, secure transition 253, Add+ 254, geo-locations 260, personal home 261, and Starbucks 263.

OS settings 210 may provide a general view of available settings. Basic OS settings 220 may provide a list of basic OS functions such as those pertaining to airplane mode and general mode.

Security sub-menu 230 provides a list of security functions such as those pertaining to auto lock and touch ID & passcode. From security sub-menu 230, a user may select a function to access a sub-menu of options that may be used to set touch ID & passcode. Security sub-menu 230 is further be used for displaying a list of biometric security and geo-location security functions. From biometric security sub-menu 240, a user may select a function to access a sub-menu of options that may be used to set device security and personal security when authenticating a transaction.

Touch ID 241 may be a software function in biometric security sub-menu 240 that opens a display that lists options for setting device and/or personal security settings based on fingerprint data (e.g., “touch ID”). Use touch ID 242 may be a sub-menu of touch ID 240 for displaying a list of security functions from which a user may set and/or add device and personal security settings.

iPhone unlock 243 may be a software function for setting the security of a specific user device 110 based on one or more pre-defined fingerprint templates such that user device 110 may be unlocked (e.g., turned on) based on fingerprint data.

Secure transaction 245 may be a software function for setting the security for communicating via user device 110 with a pre-defined third party site(s). These settings may configure the requirements for accessing a resource or for performing a transaction with a pre-defined third party site. Examples of third party sites may include iTunes, Amazon.com, and a designated bank. By selecting this feature, the operating system allows access to the security system for enabling transactions. For instance, if a bank wanted to verify the mobile device is being used by the owner/user, the selection of secure transactions 245 allows the bank to received acknowledgement that the user's smartphone has checked that there is a match to the fingerprint or other biometric input. ADD+ 246 may be a software function for inputting additional security conditions that may be controlled based on fingerprint data such as multiple fingerprints or inputting unique swipe or press patterns.

Fingerprints 247 may be a sub-menu of touch ID 240 for displaying a list of fingerprint biometric templates from which a user may view available fingerprint and/or add fingerprint biometric templates. Fingerprint 1 248 may be a first fingerprint biometric template that may be used in an authentication process. Fingerprint 1 248 may be a template of a first digit (e.g., a fingerprint or a thumbprint) of the primary user of user device 110.

ADD fingerprint 249 may be a software function for inputting additional fingerprint biometric templates. For example, one or more additional digits of the primary user of user device 110 or the fingerprint from other designated user(s) of user device 110 may be required to perform a transaction.

Geo-locations 250 is a software function in biometric security sub-menu 240 that opens a display that lists options for setting device and/or personal security settings based on geo-location data. This is where a user may configure pre-defined locations that they frequently visit. Use geo-locations 251 may be a sub-menu of geo-locations 250 for displaying a list of security functions from which a user may set and/or add device and personal security settings based on specific geo-location data.

iPhone unlock 252 may be a software function for setting the security of user device 110 based on one or more pre-defined locations. In certain instances, user device 110 may be automatically unlocked (i.e., turned on) when the device is in a certain pre-defined location. That is, when user device 110 is in a particular geo-location, their phone is automatically unlocked by setting iPhone unlock 252 to the on position.

Secure transaction 253 may be a software function for setting the security for communicating via user device 110 with one or more pre-defined third party sites. In such an instance, access to any pre-defined third party site may be allowed, and financial transactions may be authorized or denied based on the geo-location data. By selecting this feature, the operating system may be configured to allow access to the security system for enabling transactions. For instance, if a bank wanted to verify the mobile device is being used by the owner/user of a particular device, the selection of secure transactions 253 in an on position, allows the bank to receive an acknowledgement that the user's smartphone has checked that there is a match to the geo-location.

ADD+ 254 may be a software function for inputting additional security conditions that for controlling geo-location data requirements or new authorized geo-locations.

Geo-locations 260 may be a sub-menu of pre-defined geo-locations 250. Geo-location 260 sub-menu includes a list of pre-defined geo-locations, such as personal home 261, personal office 262, and Starbucks 263. In certain instances, a user may add other geo-locations to the list of pre-defined geo-locations.

Personal home 261 may be a setting for defining a user's home as a first geo-location to be used in an authentication process. In certain instances, the first geo-location may be inputted by speaking into microphone 124 to record a first geo-location. In other instances, the first geo-location may be determined using GPS coordinates provided by user device 110.

Personal office 262 may be a setting for defining a user's office as a second geo-location to be used in an authentication process. Here again, a user may use an interactive element when configuring the second geo-location. In one example, the second geo-location may be input by speaking into microphone 124 or by using GPS coordinates provided by user device 110.

Likewise, Starbucks 263 may be a setting for defining a user's local coffee shop a third geo-location to be used in an authentication process. The user may again interact with an interactive element when setting up the third geo-location. The third geo-location may also be determined using GPS coordinates provided by user device 110.

In operation, a user may have already set certain biometric security settings via biometric security sub-menu 240 and touch ID 241. On top of that, the user may select certain settings and sub-settings to get to geo-locations 250. When using geo-locations 251, the user may enable automatic unlocking of user device 110 when the device is determined to be located at one or more designated locations. One example of using geo-locations 251 may require user device 110 to be used at a certain location in order to authorize secure online access or to authorize an online purchase. The user may also add new applications to be secured via ADD+ 254. In geo-locations 260, the user may define the authorized geo-locations to one or more of personal home 261, personal office 262, and Starbucks 263.

The user may also select applications that require both biometric (e.g., fingerprint and/or voiceprint), and geo-location data to authorize a secure online access or to authorize an online purchase. In required joint security 270, the user selects secure transaction 271 to require both biometric and geo-location data to authorize the online access or the online purchase. The user may also add new applications required to be secured using ADD+ 272. By selecting this feature, the operating system allows the security system to enable transactions. For instance, if a bank wanted to verify that a mobile device is being used by the owner/user of that mobile device, the selection of secure transactions 271 allows the bank to receive an acknowledgement that the user's mobile electronic device passed both a biometric and a geo-location test.

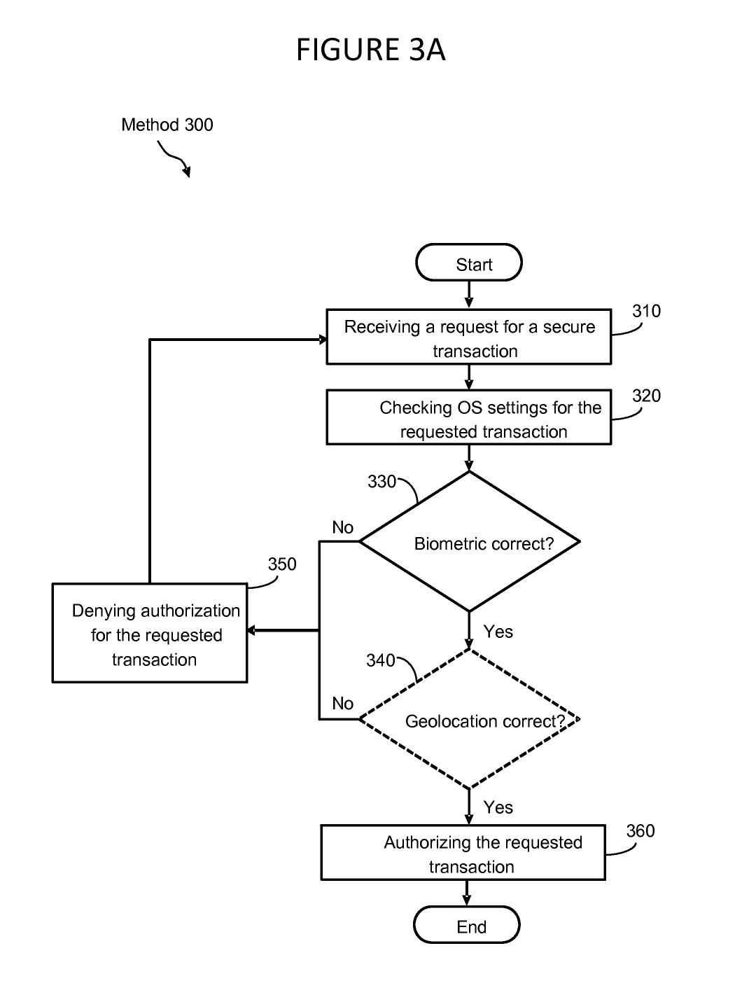

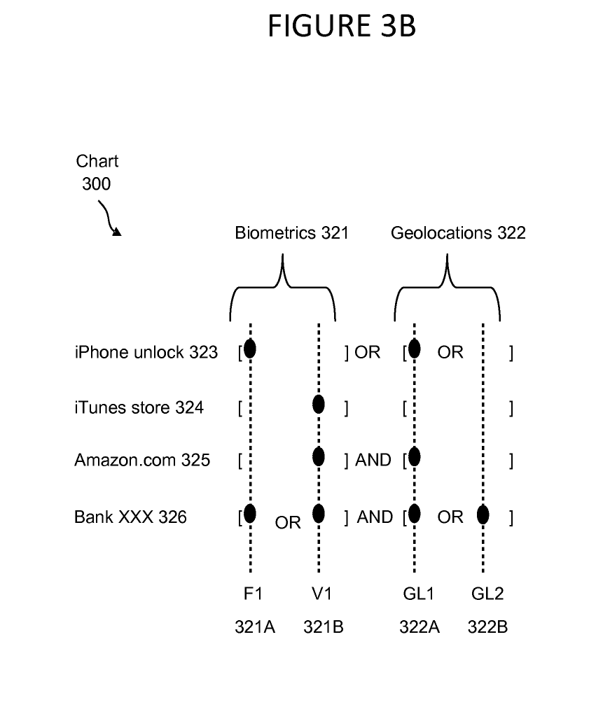

FIG. 3A is a flowchart illustrating an exemplary method for geo-location and biometric security. In step 310, a request may be received for a secure transaction. For example, a user may access an online site using user device 110.

In step 320, the operating system settings for the requested transaction may be checked. For example, biometrics and geo-locations may be reviewed to determine what biometrics and geo-locations are required to allow a particular transaction.

In step 330, it may be determined whether biometric data input into user device 110 corresponds correctly to a biometric that is already configured in user device 110. When the biometric match is determined not to be correct, the method may proceed to step 350, in which authorization is denied for the requested transaction. The method may proceeds back to step 310. When the biometric match is determined to be correct in step 330, however, the method may proceed to step 340, where it may be determined whether user device 110 is in a correct geo-location. Here again, when user device 110 is not in a correct geo-location, the method may revert to step 350. When the geo-location is determined to be the correct geo-location, the method may proceed to step 360, in which the requested transaction is authorized.

FIG. 3B is a chart of exemplary chart 300 of how resources may be secured by a system for geo-location and biometric security. Chart 300 may list resources protected by biometrics 321 and geo-locations 322 security measures. Such resources may include iPhone unlock 323, iTunes store 324 transactions, Amazon.com 325 transactions, and bank XXX 326 transactions. Biometrics 321 may include a fingerprint F1 321A and a voiceprint V1 321B. Geo-locations 322 further includes a GL1 322A and a GL2 322B.

Biometrics 321 may be a list of biometric settings that may be selected for each application. In certain instances, biometrics 321 controls the requirements to a secure transaction. F1 321A is a setting for a first fingerprint input that may be required during an authentication process. F1 321A may be a fingerprint scan of the primary user of user device 110. V1 321B may be a setting for a voice input that may be required for authentication. For example, V1 321B may correspond to a voice recording of the primary user of user device 110.

Geo-locations 322 may be a list of geo-location settings that may be selected for each application. In certain instances, these settings are used to set conditions corresponding to authorizations to perform certain secure transactions. GL1 322A may be a setting for a first geo-location input that may be used during an authentication process. GL2 322B may be a setting for a second geo-location input that may be used during an authentication process. In certain instances, geo-locations may be determined using GPS data.

iPhone unlock 323 may identify the biometric and geo-location settings required for an application on the iPhone to be unlocked. As illustrated, unlocking the iPhone may require either F1 321A or GL1 322A to be verified before user device 110 may be unlocked. As such, user device 110 may be unlocked via either authentication of fingerprint input or via authentication of first geo-location 130. In this example, user device may be automatically unlocked when user device 110 is at first geo-location 130.

As illustrated, iTunes store 324 is configured to use V1 321B when authorizing access to the iTunes store 324. iTunes store 324 may therefore be accessed solely by using voice recognition.

Likewise, Amazon.com 325 is illustrated as being configured to require both V1 321B and geo-location GL1 322A to authorize transactions on Amazon.com 325. In this example, Amazon.com may be accessed only using a combination of a specific voice biometric and a specific first geo-location 130.

Bank XXX 326 is illustrated as also requiring both biometric and geo-location settings for an online banking application. Either F1 321A or V1 321B may provide the required biometric, and either GL1 322A or GL2 322B may provide the required geo-location to be validated before a user may perform a banking transaction with bank XXX. In this example, the online banking application may only be accessed when a fingerprint input or a voice recording and either first geo-location 130 or second geo-location 132 are verified.

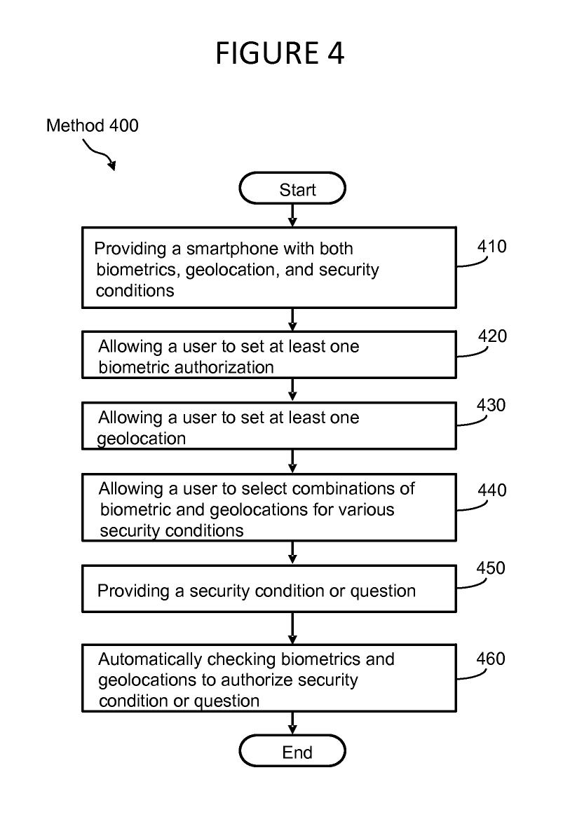

FIG. 4 is a flowchart illustrating an alternative method for geo-location and biometric security. In step 410, a smartphone may be provided with the ability to process biometrics, geo-location, and security conditions. As such, user device 110 may be configured or initialized so as to enable one or more sensors, geo-locations, and security conditions that may be used during an authentication process.

In step 420, a user may set at least one biometric authorization. For example, the user may set up one or more biometrics using OS settings 118. For example, a user may input a fingerprint by selecting a template in ADD fingerprint 249 and then entering a fingerprint template using fingerprint sensor 122. The fingerprint template may be stored in database 120 and used in future authentication processes.

In step 430, the user may set at least one geo-location authorization. For example, the user may define the location of their home in personal home 261 by speaking into microphone 124 to record the location. Alternatively, the location may be determined by a GPS location program in user device 110.

In step 440, the user may select combinations of biometric and geo-locations for various security conditions. For example, the user may select a fingerprint and a voiceprint as security conditions to be met before allowing access or transactions to occur via an application, such as iPhone unlock, iTunes store, Amazon.com, and online banking.

In step 450, a security condition or question may be provided. For example, a security condition or question may be presented to the user during an authentication process. Such security conditions and questions may be stored in database 120 of user device 110. In step 460, biometrics and geo-locations may be automatically checked to authorize access to a certain resource.

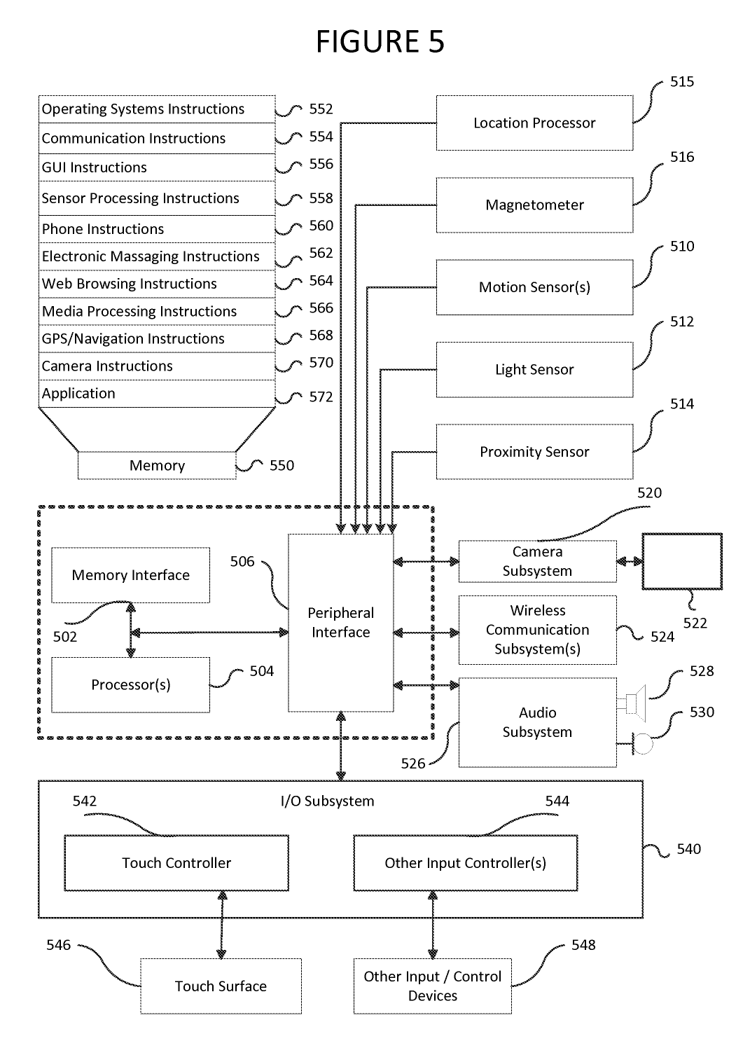

FIG. 5 illustrates an exemplary device architecture of a device that may be used in a system for geo-location and biometric security. Architecture 500 can be implemented in any number of portable devices including but not limited to smart phones, electronic tablets, and gaming devices. Architecture 500 as illustrated in FIG. 5 includes memory interface 502, processors 504, and peripheral interface 506. Memory interface 502, processors 504 and peripherals interface 506 can be separate components or can be integrated as a part of one or more integrated circuits. The various components can be coupled by one or more communication buses or signal lines.

Processors 504 as illustrated in FIG. 5 are meant to be inclusive of data processors, image processors, central processing unit, or any variety of multi-core processing devices. Any variety of sensors, external devices, and external subsystems can be coupled to peripherals interface 506 to facilitate any number of functionalities within the architecture 500 of the exemplar mobile device. For example, motion sensor 510, light sensor 512, and pro5imity sensor 514 can be coupled to peripherals interface 506 to facilitate orientation, lighting, and pro5imity functions of the mobile device. For example, light sensor 512 could be utilized to facilitate adjusting the brightness of touch surface 546. Motion sensor 510, which could be exemplified in the context of an accelerometer or gyroscope, could be utilized to detect movement and orientation of the mobile device. Display objects or media could then be presented according to a detected orientation (e.g., portrait or landscape).

Other sensors could be coupled to peripherals interface 506, such as a temperature sensor, a biometric sensor, or other sensing device to facilitate corresponding functionalities. Location processor 515 (e.g., a global positioning transceiver) can be coupled to peripherals interface 506 to allow for generation of geo-location data thereby facilitating geo-positioning. An electronic magnetometer 516 such as an integrated circuit chip could in turn be connected to peripherals interface 506 to provide data related to the direction of true magnetic North whereby the mobile device could enjoy compass or directional functionality. Camera subsystem 520 and an optical sensor 522 such as a charged coupled device (CCD) or a complementary metal-oxide semiconductor (CMOS) optical sensor can facilitate camera functions such as recording photographs and video clips.

Communication functionality can be facilitated through one or more communication subsystems 524, which may include one or more wireless communication subsystems. Wireless communication subsystems 524 can include 802.5 or Bluetooth transceivers as well as optical transceivers such as infrared. Wired communication system can include a port device such as a Universal Serial Bus (USB) port or some other wired port connection that can be used to establish a wired coupling to other computing devices such as network access devices, personal computers, printers, displays, or other processing devices capable of receiving or transmitting data. The specific design and implementation of communication subsystem 524 may depend on the communication network or medium over which the device is intended to operate. For example, a device may include wireless communication subsystem designed to operate over a global system for mobile communications (GSM) network, a GPRS network, an enhanced data GSM environment (EDGE) network, 802.5 communication networks, code division multiple access (CDMA) networks, or Bluetooth networks. Communication subsystem 524 may include hosting protocols such that the device may be configured as a base station for other wireless devices. Communication subsystems can also allow the device to synchronize with a host device using one or more protocols such as TCP/IP, HTTP, or UDP.

Audio subsystem 526 can be coupled to a speaker 528 and one or more microphones 530 to facilitate voice-enabled functions. These functions might include voice recognition, voice replication, or digital recording. Audio subsystem 526 in conjunction may also encompass traditional telephony functions.

I/O subsystem 540 may include touch controller 542 and/or other input controller(s) 544. Touch controller 542 can be coupled to a touch surface 546. Touch surface 546 and touch controller 542 may detect contact and movement or break thereof using any of a number of touch sensitivity technologies, including but not limited to capacitive, resistive, infrared, or surface acoustic wave technologies. Other pro5imity sensor arrays or elements for determining one or more points of contact with touch surface 546 may likewise be utilized. In one implementation, touch surface 546 can display virtual or soft buttons and a virtual keyboard, which can be used as an input/output device by the user.

Other input controllers 544 can be coupled to other input/control devices 548 such as one or more buttons, rocker switches, thumb-wheels, infrared ports, USB ports, and/or a pointer device such as a stylus. The one or more buttons (not shown) can include an up/down button for volume control of speaker 528 and/or microphone 530. In some implementations, device 500 can include the functionality of an audio and/or video playback or recording device and may include a pin connector for tethering to other devices.

Memory interface 502 can be coupled to memory 550. Memory 550 can include high-speed random access memory or non-volatile memory such as magnetic disk storage devices, optical storage devices, or flash memory. Memory 550 can store operating system 552, such as Darwin, RT5C, LINUS, UNI5, OS 5, ANDROID, WINDOWS, or an embedded operating system such as V5Works. Operating system 552 may include instructions for handling basic system services and for performing hardware dependent tasks. In some implementations, operating system 552 can include a kernel.

Memory 550 may also store communication instructions 554 to facilitate communicating with other mobile computing devices or servers. Communication instructions 554 can also be used to select an operational mode or communication medium for use by the device based on a geographic location, which could be obtained by the GPS/Navigation instructions 568. Memory 550 may include graphical user interface instructions 556 to facilitate graphic user interface processing such as the generation of an interface; sensor processing instructions 558 to facilitate sensor-related processing and functions; phone instructions 560 to facilitate phone-related processes and functions; electronic messaging instructions 562 to facilitate electronic-messaging related processes and functions; web browsing instructions 564 to facilitate web browsing-related processes and functions; media processing instructions 566 to facilitate media processing-related processes and functions; GPS/Navigation instructions 568 to facilitate GPS and navigation-related processes, camera instructions 570 to facilitate camera-related processes and functions; and instructions 572 for any other application that may be operating on or in conjunction with the mobile computing device. Memory 550 may also store other software instructions for facilitating other processes, features and applications, such as applications related to navigation, social networking, location-based services or map displays.

Each of the above identified instructions and applications can correspond to a set of instructions for performing one or more functions described above. These instructions need not be implemented as separate software programs, procedures, or modules. Memory 550 can include additional or fewer instructions. Furthermore, various functions of the mobile device may be implemented in hardware and/or in software, including in one or more signal processing and/or application specific integrated circuits.

Certain features may be implemented in a computer system that includes a back-end component, such as a data server, that includes a middleware component, such as an application server or an Internet server, or that includes a front-end component, such as a client computer having a graphical user interface or an Internet browser, or any combination of the foregoing. The components of the system can be connected by any form or medium of digital data communication such as a communication network. Some examples of communication networks include LAN, WAN and the computers and networks forming the Internet. The computer system can include clients and servers. A client and server are generally remote from each other and typically interact through a network. The relationship of client and server arises by virtue of computer programs running on the respective computers and having a client-server relationship to each other.

One or more features or steps of the disclosed embodiments may be implemented using an API that can define on or more parameters that are passed between a calling application and other software code such as an operating system, library routine, function that provides a service, that provides data, or that performs an operation or a computation. The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API. In some implementations, an API call can report to an application the capabilities of a device running the application, such as input capability, output capability, processing capability, power capability, and communications capability.

While various embodiments have been described above, it should be understood that they have been presented by way of example only, and not limitation. The descriptions are not intended to limit the scope of the invention to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the invention as defined by the appended claims and otherwise appreciated by one of ordinary skill in the art. The scope of the invention should, therefore, be determined not with reference to the above description, but instead should be determined with reference to the appended claims along with their full scope of equivalents.

1. A method for providing security on a mobile electronic device, the method comprising:
receiving a selection via a user interface of the mobile electronic device from a user of the mobile electronic device, the selection associating a pre-defined resource with a pre-defined geo-location;
storing the received selection that associates the pre-defined resource with the pre-defined geo-location in a memory;
receiving a request over the user interface to access the pre-defined resource;
identifying a current location of the mobile device by a positioning system at the mobile electronic device;
executing instructions stored in the memory, wherein execution of the instructions by a processor:
retrieves the pre-defined geo-location associated with the pre-defined resource,
identifies that the pre-defined geo-location matches the current location of the mobile electronic device, and
grants access to the pre-defined resource based on the identified match between the current location of the mobile electronic device and the pre-defined geo-location.

2. The method of claim 1, further comprising receiving user input defining one or more geo-location security conditions.

3. The method of claim 1, wherein the pre-defined resource is further associated with one or more biometric security conditions.

4. The method of claim 3, wherein a first geo-location security condition and a second geo-location security condition are associated with different biometric security conditions.

5. The method of claim 1, wherein the pre-defined resource is at least one of an application on the mobile electronic device, an application on a website, and an application that performs a financial transaction.

6. The method of claim 1, wherein the pre-defined resource is further associated with one or more security questions.

7. The method of claim 6, wherein a first geo-location security condition and a second geo-location security condition are associated with different security questions.

8. An apparatus for providing security on a mobile electronic device, the apparatus comprising:
a global positioning system (GPS) that identifies a current location of the mobile electronic device;
memory that stores information regarding a plurality of pre-defined resources, wherein each resource of the plurality of pre-defined resources are associated with a specific pre-defined geo-location of a plurality of pre-defined geo-locations;
a user interface that receives a selection that associates a first pre-defined resource of the plurality of pre-defined resources with a first pre-defined geo-location, wherein the user interface receives a request to access the first pre-defined resource;
a processor that executes instructions stored in memory, wherein execution of the instructions by the processor:
retrieves the first pre-defined geo-location associated with the first pre-defined resource,
identifies that the first pre-defined geo-location matches a current location of the mobile electronic device, and
grants access to the first pre-defined resource based on the identified match between the current location of the mobile electronic device and the first geo-location.

9. The apparatus of claim 8, wherein the user interface further receives user input defining one or more geo-location security conditions.

10. The apparatus of claim 8, wherein the selected resource is further associated with one or more biometric security conditions.

11. The apparatus of claim 10, wherein a first geo-location security condition and a second geo-location security condition are associated with different biometric security conditions.

12. The apparatus of claim 8, wherein the pre-defined resource is at least one of an application on the mobile electronic device, an application on a website, and an application that performs a financial transaction.

13. The apparatus of claim 8, wherein the pre-defined resource is further associated with one or more security questions.

14. The apparatus of claim 13, wherein a first geo-location security condition and a second geo-location security condition are associated with different security questions.

15. A non-transitory computer-readable storage medium, having embodied thereon a program executable by a processor to perform a method for providing security on a mobile electronic device, the method comprising:
receiving a selection via a user interface of the mobile electronic device from a user of the mobile electronic device from a user of the mobile electronic device, the selection associating a pre-defined resource with a pre-defined geo-location;
storing the received selection that associates the pre-defined resource with the pre-defined geo-location in a memory;
receiving a request over the user interface to access the pre-defined resource;
identifying a current location of the mobile device by a positioning system at the mobile electronic device;
retrieving the pre-defined geo-location associated with the pre-defined resource;
identifying that the pre-defined geo-location matches a current location of the mobile electronic device; and
granting access to the pre-defined resource based on the identified match between the current location of the mobile electronic device and the pre-defined geo-location.

16. The non-transitory computer-readable storage medium of claim 15, further comprising receiving user input defining one or more geo-location security conditions.

17. The non-transitory computer-readable storage medium of claim 15, wherein the pre-defined resource is further associated with one or more biometric security conditions.

18. The non-transitory computer-readable storage medium of claim 17, wherein a first geo-location security condition and a second geo-location security condition are associated with different biometric security conditions.

19. The non-transitory computer-readable storage medium of claim 15, wherein the pre-defined resource is further associated with one or more security questions.

20. The non-transitory computer-readable storage medium of claim 19, wherein a first geo-location security condition and a second geo-location security condition are associated with different security questions.
